(19) United States
(12) Patent Application Publication
(10) Pub. No.: US 2006/0293022 A1
(43) Pub. Date: Dec. 28, 2006

(54) Emergency session handling over a communication network

(75) Inventors: Dinesh K. Jindal, Naperville, IL (US); Venkateshwar Nandam, Naperville, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/168,192

(22) Filed: Jun. 28, 2005

(51) Int. Cl. H04M 11/04

(52) U.S. Cl. 455/404.1

(57) ABSTRACT

Emergency session systems and corresponding methods are described that allow a subscriber to initiate an emergency session over a communication network in anticipation of an emergency event. The emergency session system includes a subscriber database that is operable to store a plurality of subscriber profiles for a plurality of subscribers subscribing to an emergency service offered by a service provider. Responsive to initiating an emergency session for a subscriber, a control system accesses the subscriber database to identify a subscriber profile for the subscriber. The control system identifies a first set of parameters for the emergency session from the subscriber profile, and performs actions based on the first set of parameters. The parameters may be pre-defined by the subscriber or dynamically entered by the subscriber.

### BACKGROUND OF THE INVENTION

1. Field of the Invention

The invention is related to the field of communications and, in particular, to an emergency session system and corresponding methods for handling emergency sessions in a communication network. More particularly, the invention allows a person to initiate an emergency session over a communication network in anticipation of an emergency event, and the communication network performs one or more actions during the emergency session as designated by the person.

2. Statement of the Problem

People frequently use communication networks on a daily basis at work, at home, and on the road. Consequently, many people carry a mobile communication device, such as a cell phone, a PDA, a BlackBerry, etc, when they are in transit. At home, people have access to a landline phone and/or a PC connected to a public network. With this access to communication devices, people are able to contact emergency services, such as 911 services, in case of an emergency event (e.g., a fire, a medical emergency, a burglary, etc).

“911” has been designated in the United States as the number to be used by the public to summon emergency aid or to report a crime, fire, or accident. A caller in response to an emergency event dials 9-1-1 on their telephone. In the original 911 service, known as Basic 911 (B911), the call is routed to one centralized answering location. The agent at the answering location converses with the caller to obtain pertinent information on the emergency event. The agent then determines the appropriate agency or emergency personnel to dispatch, and dials the number to transfer the caller to that agency. Enhanced 911 services, or E911, provide some enhancements to the Basic 911 service. For instance, E911 automatically provides the agent with information on the caller, such as a street address, medical conditions, etc. That way if the caller is incapacitated in some manner, then the emergency personnel would be able to go to the location of the caller.

Although 911 services have worked well in many situations, there are some limitations. One limitation with 911 services is that an emergency event is taking place or has taken place, and the caller placing the 911 call is reacting or responding to that emergency event. 911 services are not really meant to be a preventative measure, but more of a response to an event that has already taken place. Another limitation with 911 services is that a person may need to call 911 after an emergency event, when the emergency event may incapacitate that person who is unable to place the 911 call.

It may be desirable to use communication networks in a different and improved manner to handle emergency events.

### SUMMARY OF THE SOLUTION

The invention solves the above problems and other problems with a network-based solution for initiating an emergency session in anticipation of an emergency event, danger, or some equivalent event. A person may initiate the emergency session through a cell phone, a wireline phone, a computer, a specialized device, or some other communication device, in anticipation of an emergency event. With the emergency session established, the communication network performs one or more actions as pre-defined by the person or dynamically defined through the communication device. For instance, one action may be that the network periodically places calls to the person to ensure that the person is able to answer the phone. Another action may be that the network informs loved ones that a problem may be imminent with this person. Another action may be that the network contacts emergency personnel after a time period.

This network-based solution advantageously allows a person to initiate the emergency session before an event actually happens, not after. If this person becomes incapacitated by the event, the emergency session has already been established and proper actions may take place, such as contacting emergency personnel. This network-based solution is also advantageously fully customizable so that the person may define what action or actions take place during the emergency session.

One embodiment of the invention includes an emergency session system of a communication network. The emergency session system comprises a control system and a subscriber database. The subscriber database is operable to store a plurality of subscriber profiles for a plurality of subscribers. The subscribers are subscribing to an emergency service offered by a service provider, such as Verizon, Qwest, or another service provider. As part of the emergency service, each subscriber creates a subscriber profile where the subscriber pre-defines one or more parameters for an emergency session. If a subscriber wishes to initiate an emergency session, then that subscriber enters a code, dials a number, or performs some other function to cause his/her communication device to transmit a message to the emergency session system. The subscriber initiates the emergency session in anticipation of an emergency event, such as a medical condition, danger, etc. The control system of the emergency session system receives the message from the subscriber, and initiates an emergency session for the subscriber. The control system accesses the subscriber database to identify a subscriber profile for the subscriber. The control system identifies a first set of parameters for the emergency session from the subscriber profile. The subscriber may also dynamically define other parameters by transmitting subsequent messages to the emergency session system. The control system then performs one or more actions based on the first set of parameters and/or based on the parameters received in the subsequent messages from the subscriber during the emergency session.

One particular action performed by the control system may be setting a session timer upon initiation of the emergency session. The session timer may be ten minutes, thirty minutes, an hour, or another defined time. The control system then monitors the session timer for a time out. If the control system receives a message to clear the emergency session before the session timer times out, then the control system may end the emergency session or may restart the session timer. If the session timer times out, then the control system identifies a second set of parameters for the emergency session from the subscriber profile. The control system performs actions based on the second set of parameters.

The invention may include other exemplary embodiments described below.

### DESCRIPTION OF THE DRAWINGS

The same reference number represents the same element on all drawings.

FIG. 1 illustrates a communication network in an exemplary embodiment of the invention.

FIG. 2 is a flow chart illustrating a method of operating an emergency session system of the communication network in FIG. 1 in an exemplary embodiment of the invention.

FIG. 3 is a flow chart illustrating a method of operating an emergency session system upon the setting of a session timer in an exemplary embodiment of the invention.

FIG. 4 illustrates another communication network in an exemplary embodiment of the invention.

### DETAILED DESCRIPTION OF THE INVENTION

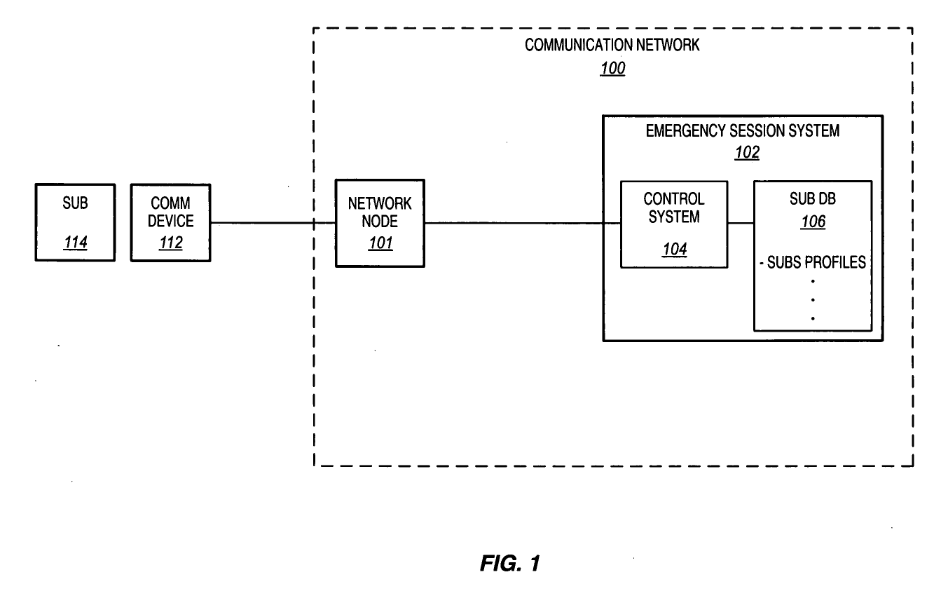

FIGS. 1-4 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 may comprise a wireless network, a circuit-based network, a packet-based network, or any combination thereof. Communication network 100 includes a network node 101 and an emergency session system 102. Network node 101 is operable to connect to a communication device (COMM DEVICE) 112. Communication device 112 is being operated by subscriber (SUB) 114. Network node 101 comprises any node operable to receive a call, signaling, a message, or any other type of information from communication device 112. Network node 101 may comprise a switch, a Mobile Switching Center (MSC), an Internet Service Provider (ISP), or some other system depending on the type of communication device 112. Communication network 100 may include other components, devices, or systems not shown in FIG. 1.

Emergency session system 102 comprises a control system 104 and a subscriber database (SUB DB) 106. Emergency session system 102 may comprise other systems, devices, or components not shown in FIG. 1. Subscriber database 106 may comprise a single database or may be distributed among multiple databases. Subscriber database 106 is operable to store a plurality of subscriber profiles for a plurality of subscribers. The subscribers are subscribing to an emergency service offered by a service provider, such as Verizon, Qwest, or another service provider. As part of the emergency service, each subscriber creates a subscriber profile where the subscriber pre-defines one or more parameters for an emergency session. Some of the parameters may be defaults defined by the service provider. Other parameters may be defined and fully customized by the subscriber. Subscriber database 106 thus includes a subscriber profile for subscriber 114.

Control system 104 may comprise instructions executable by a processing system. Some examples of instructions are software, program code, and firmware. The instructions are operational when executed by the processing system to direct the processing system to operate in accordance with the invention. The term “processing system” refers to a single processing device or a group of inter-operational processing devices. Some examples of processors are computers, integrated circuits, and logic circuitry.

When in operation, the subscriber 114 transmits a message to communication network 100 through communication device 112 to initiate an emergency session. The subscriber 114 transmits the message in anticipation of an emergency event, such as a medical condition, danger, etc. The message may comprise a phone call, a specialized code from a telephone, a message to a Universal Resource Locator (URL), etc. Network node 101 receives the message and routes the message to emergency session system 102. There may be many more network nodes or network elements between network node 101 and emergency session system 102 for routing the message that are not shown for the sake of brevity.

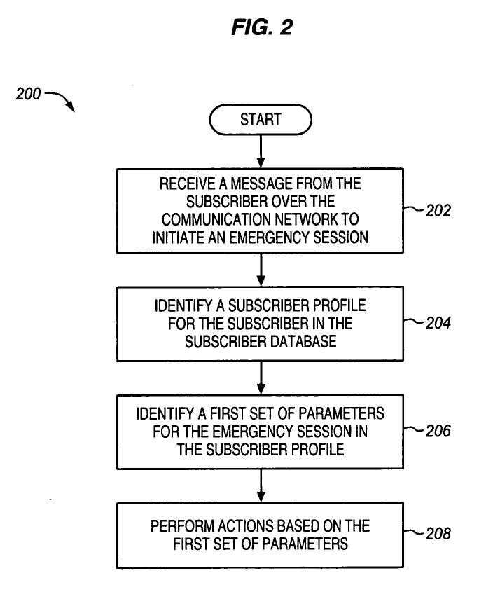

FIG. 2 is a flow chart illustrating a method 200 of operating emergency session system 102 in an exemplary embodiment of the invention. Method 200 may not be all-inclusive and may include other steps not shown.

In step 202, control system 104 receives the message from the subscriber 114 over communication network 100. The message causes control system 104 to initiate an emergency session for the subscriber 114. The message may include information on the subscriber 114, such as a telephone number of the subscriber 114 or some other subscriber identifier. The message may also identify a particular type of emergency session. As an example, one type of message may indicate a medical emergency. Another type of message may indicate a fire emergency.

In step 204, control system 104 accesses the subscriber database 106 to identify a subscriber profile for the subscriber 114. The message from the subscriber 114 may include some type of subscriber identifier that control system 104 uses to locate the subscriber profile for subscriber 114. In step 206, control system 104 identifies a first set of parameters for the emergency session from the subscriber profile. The first set of parameters in the subscriber profile is pre-defined by the subscriber 114. The subscriber 114 may also dynamically define other parameters by transmitting subsequent messages to emergency session system 102 through communication device 112.

In step 208, control system 104 performs one or more actions based on the first set of parameters during the emergency session. Control system 104 may also perform actions based on the parameters received in the subsequent messages from the subscriber 114. As an example, control system 104 may, as one possible action, transmit periodic messages to the subscriber 114 to ensure that subscriber 114 is able to respond to the messages. Control system 104 may also track the location of the subscriber 114 via GPS, triangulation, or another technology. Control system 104 may also remotely monitor the status of a medical device, such as a pace maker or a blood pressure machine. Control system 104 may also notify one or more individuals defined by the subscriber 114 of a potential emergency.

One particular action performed by control system 104 may be setting a session timer upon initiation of the emergency session. The time set for the session timer may be pre-defined by the subscriber 114 or received dynamically from the subscriber 114.

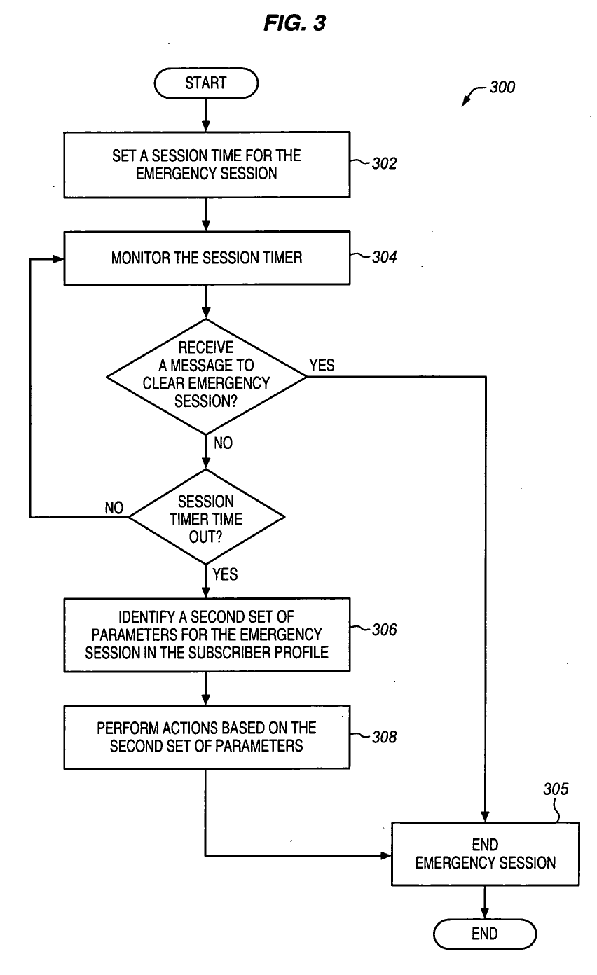

FIG. 3 is a flow chart illustrating a method 300 of operating emergency session system 102 upon the setting of a session timer in an exemplary embodiment of the invention. Step 302 stems from step 208 in method 200. In step 302, control system 104 sets a session timer for the emergency session initiated by the subscriber 114. The session timer may be ten minutes, thirty minutes, an hour, or another defined time. Control system 104 then monitors the session timer for a time out in step 304.

If control system 104 receives a message to clear the emergency session before the session timer times out, then control system 104 may end the emergency session in step 305 or may restart the session timer. The message to clear the emergency session may be transmitted by the subscriber 114. The message to clear the emergency session may alternatively be transmitted by another authorized party, such as a relative.

If the session timer times out, then control system 104 identifies a second set of parameters for the emergency session from the subscriber profile in step 306. The second set of parameters in the subscriber profile is pre-defined by the subscriber 114. The subscriber 114 may also dynamically define other parameters by transmitting subsequent messages to emergency session system 102 through communication device 112. In step 308, control system 104 performs actions based on the second set of parameters. Control system 104 may also perform actions based on the parameters received in the subsequent messages from the subscriber 114. As an example, control system 104 may, as one possible action, contact emergency personnel, such as by dialing 911 services. Control system 104 may also remotely control a medical device, such as a pacemaker. Control system 104 may also notify one or more individuals defined by the subscriber 114 of a potential emergency. Control system 104 may then end the emergency session in step 305.

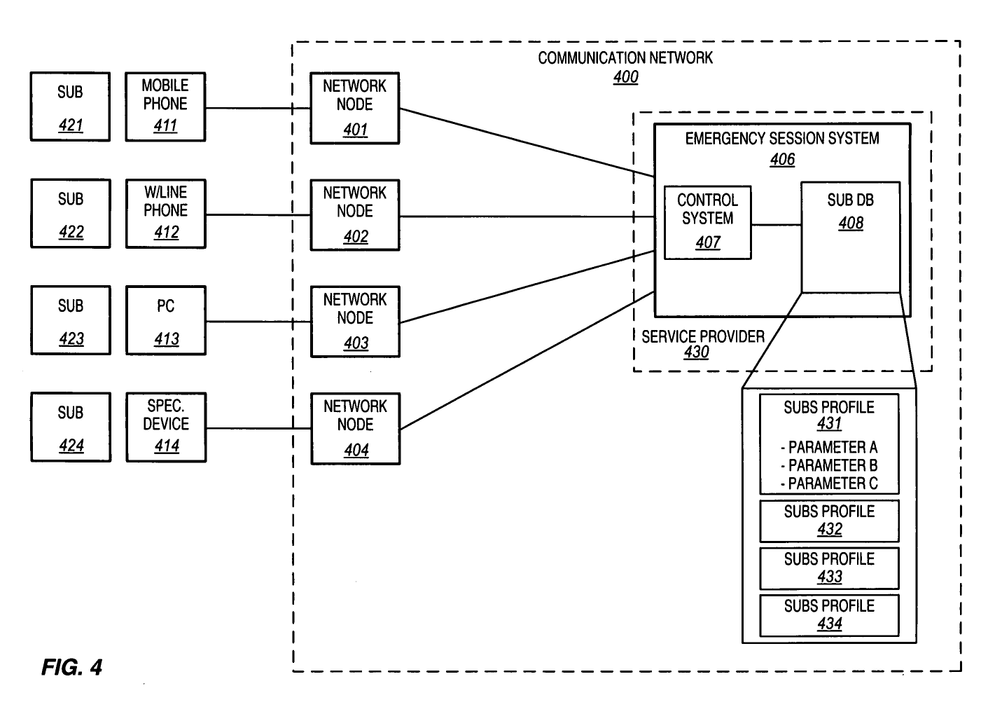

FIG. 4 illustrates another communication network 400 in an exemplary embodiment of the invention. Communication network 400 includes a plurality of network nodes 401-404 and an emergency session system 406. Network node 401 is operable to connect to a mobile phone 411. Network node 401 may comprise an MSC in this embodiment. Network node 402 is operable to connect to a wireline or landline phone 412. Network node 402 may comprise a switch, such as a 5ESS, in this embodiment. Network node 403 is operable to connect to a PC 413. Network node 403 may comprise an ISP in this embodiment. Network node 404 is operable to connect to a specialized device 414. The specialized device 414 comprises any device that is used in conjunction with an emergency session service offered by a service provider. Network node 404 may be an MSC, a switch, or some other node in this embodiment depending on the communication capabilities of specialized device 414. Communication network 400 may include other components, devices, or systems not shown in FIG. 4.

Emergency session system 406 comprises a control system 407 and a subscriber database (SUB DB) 408. Emergency session system 406 may include other systems, devices, or components not shown in FIG. 4. Subscriber database 408 may comprise a single database or may be distributed among multiple databases. Subscriber database 408 is operable to store a plurality of subscriber profiles for a plurality of subscribers. The subscribers are subscribing to an emergency service offered by a service provider 430, such as Verizon, Qwest, or another service provider. As part of the emergency service, each subscriber creates a subscriber profile where the subscriber pre-defines one or more parameters for an emergency session. Subscriber database 408 includes a subscriber profile 431 for subscriber 421. Subscriber database 408 includes a subscriber profile 432 for subscriber 422. Subscriber database 408 includes a subscriber profile 433 for subscriber 423. Subscriber database 408 includes a subscriber profile 434 for subscriber 424. Each subscriber profile 431-434 has one or more pre-defined parameters for the subscriber.

When in operation, subscriber 421 wishes to initiate an emergency session with communication network 400. Assume for example that subscriber 421 is hiking into an area that may be dangerous due to animals, weather, etc. Before entering that area and in anticipation of an emergency event, subscriber 421 dials an activation code, such as *01, into mobile phone 411. Mobile phone 411 transmits the activation code to communication network 400 to initiate an emergency session. There is a radio access network between mobile phone 411 and network node 401 to transport the activation code from mobile phone 411 to network node 401.

Responsive to receiving the activation code, network node 401 routes a message to emergency session system 406. Network node 401 may transmit the activation code to emergency session system 406. Alternatively, network node 401 may process the activation code to generate a specialized message for emergency session system 406. The specialized message may include information on subscriber 421, information on the mobile phone 411, etc. The specialized message may also indicate a particular type of emergency, such as a medical emergency, a fire emergency, etc.

Control system 407 in emergency session system 406 receives the message from network node 401. The message causes control system 407 to initiate an emergency session for the subscriber 421. At this point, the emergency session may be in an “emergency watch” mode. The message may include information on the subscriber 421, such as a telephone number of the subscriber 421 or some other subscriber identifier. The message may also identify a particular type of emergency, such as a medical emergency, a fire emergency, etc.

Control system 407 accesses the subscriber database 408 to identify a subscriber profile 431 for the subscriber 421. The message from the subscriber 421 may include some type of subscriber identifier that control system 407 uses to locate the subscriber profile 431 for subscriber 421. Control system 407 identifies one or more parameters (e.g., parameter A, parameter B, and parameter C) for the emergency session from the subscriber profile 431. The parameters in the subscriber profile 431 are pre-defined by the subscriber 421.

Control system 407 performs actions based on the parameters. As an example, control system 407 may, as one possible action, transmit periodic messages to the subscriber 421 to ensure that the subscriber 421 is able to respond to the messages. Control system 407 may also track the location of the subscriber 421 via GPS, triangulation, or another technology.

One particular action performed by control system 407 may be setting a session timer upon initiation of the emergency session. The time set for the session timer may be pre-defined by the subscriber 421. The session timer may be ten minutes, thirty minutes, an hour, or another other defined time. Control system 407 then monitors the session timer for a time out. If the subscriber 421 does not check in or respond to messages from the emergency session system 406 before the session timer times out, then the emergency session system 406 may perform other actions. The emergency session may then switch from “emergency watch” mode to “emergency threat” mode. Control system 407 identifies parameters for the emergency session from the subscriber profile 431 responsive to a time out. Control system 407 then performs actions based on these time out parameters. One action may comprise contacting emergency personnel in the area of subscriber 421. Another action may comprise notifying one or more contact people (i.e., a spouse, friend, parent, etc) defined by the subscriber 421 as to the situation. Control system 407 may end the emergency session at this point or take actions based upon the subscriber profile or real-time instructions from the subscriber's representative if so pre-defined by the subscriber.

In addition to the pre-defined parameters, the subscriber 421 may dynamically define other parameters by transmitting subsequent messages or codes to emergency session system 406. As an example, subscriber 421 may reset, reduce, or extend the session timer by dialing *02 or another code into mobile phone 411. Subscriber 421 may enter a code (e.g., *03) elevating the emergency session from the “emergency watch” mode to the “emergency threat” mode.

If the subscriber 421 ends his/her hike or no longer anticipates a potential emergency event, then subscriber 421 may enter a clear code (e.g., *04) to end the emergency session. Control system 407 receives a message to clear the emergency session and ends the current emergency session for the subscriber 421. Control system 407 may update the subscriber profile with any relevant information.

The clear code may be password protected to ensure that an authorized person has ended the emergency session. For instance, if the subscriber 421 is abducted, then the abductor should not be able to end the emergency session. The subscriber 421 may also define that only another authorized person may enter the clear code. For instance, a spouse may only end the session after it is confirmed that the subscriber is not in danger.

Subscribers 422-424 may initiate emergency sessions in a similar manner in anticipation of an emergency event. Subscriber 422 may dial codes as described above to initiate an emergency session. Subscriber 423 may enter a URL or some other type of link or message to initiate an emergency session. Subscriber 424 may press a specialized button that transmits the proper code or message to initialize an emergency session.

The system would also define additional interfaces (via activation codes over a phone or directly over the internet via a PC) between the subscriber 421-424 and the subscriber profile 431-434 to define and maintain the subscriber profile after proper authentication. A subscriber does not have to be in an emergency watch/threat mode to maintain a profile.

Although specific embodiments were described herein, the scope of the invention is not limited to those specific embodiments. The scope of the invention is defined by the following claims and any equivalents thereof.

We claim:

1. An emergency session system for a communication network, the emergency session system comprising:
a subscriber database operable to store a plurality of subscriber profiles for a plurality of subscribers subscribing to an emergency service offered by a service provider; and
a control system operable to receive a first message from a subscriber over the communication network to initiate an emergency session, to access the subscriber database to identify a subscriber profile for the subscriber, identify a first set of parameters for the emergency session from the subscriber profile, and to perform actions based on the first set of parameters during the emergency session.

2. The emergency session system of claim 1 wherein the control system receives the first message from the subscriber in anticipation of an emergency event to initiate the emergency session.

3. The emergency session system of claim 1 wherein one of the actions performed by the control system comprises setting a session timer based on the first set of parameters.

4. The emergency session system of claim 3 wherein another one of the actions performed by the control system comprises transmitting periodic messages to the subscriber, tracking the location of the subscriber, or notifying a person defined by the subscriber.

5. The emergency session system of claim 3 wherein if the session timer times out, then the control system is operable to:
identify a second set of parameters for the emergency session from the subscriber profile; and
perform actions based on the second set of parameters.

6. The emergency session system of claim 5 wherein one of the actions performed by the control system comprises contacting emergency personnel.

7. The emergency session system of claim 3 wherein the control system is operable to receive a second message to clear the emergency session before the session timer times out.

8. The emergency session system of claim 7 wherein the control system is further operable to receive the second message from the subscriber or from another authorized party defined in the subscriber profile.

9. The emergency session system of claim 1 wherein the control system is operable to:
receive a subsequent message from the subscriber defining parameters for the emergency session;
identify the parameters defined in the subsequent message; and
perform actions based on the parameters defined in the subsequent message.

10. The emergency session system of claim 1 wherein the first set of parameters are pre-defined by the subscriber.

11. A method of operating an emergency session system for a communication network, the method comprising:
storing a plurality of subscriber profiles for a plurality of subscribers subscribing to an emergency service offered by a service provider in a subscriber database;
receiving a first message from a subscriber into the communication network to initiate an emergency session;
accessing the subscriber database to identify a subscriber profile for the subscriber;
identifying a first set of parameters for the emergency session from the subscriber profile; and
performing actions based on the first set of parameters during the emergency session.

12. The method of claim 11 wherein receiving a first message from a subscriber further comprises:
receiving the first message from the subscriber in anticipation of an emergency event to initiate the emergency session.

13. The method of claim 11 wherein performing actions based on the first set of parameters further comprises:
setting a session timer based on the first set of parameters.

14. The method of claim 13 wherein performing actions based on the first set of parameters further comprises:
transmitting periodic messages to the subscriber, tracking the location of the subscriber, or notifying a person defined by the subscriber.

15. The method of claim 13 wherein if the session timer times out, then the method further comprises:
identifying a second set of parameters for the emergency session from the subscriber profile; and
performing actions based on the second set of parameters.

16. The method of claim 15 wherein performing actions based on the second set of parameters further comprises:
contacting emergency personnel.

17. The method of claim 13 further comprising:
receiving a second message to clear the emergency session before the session timer times out.

18. The method of claim 17 wherein receiving a second message further comprises:
receiving the second message from the subscriber or from another authorized party defined in the subscriber profile.

19. The method of claim 11 further comprising:
receiving a subsequent message from the subscriber defining parameters for the emergency session;
identifying the parameters defined in the subsequent message; and
performing actions based on the parameters defined in the subsequent message.

20. The method of claim 11 wherein the first set of parameters is pre-defined by the subscriber.
